(19) United States
(12) Patent Application Publication
(10) Pub. No.: US 2016/0321786 A1
(43) Pub. Date: Nov. 3, 2016

(54) DISPLAY DEVICE AND PICTURE DISPLAY METHOD

(71) Applicants: Boe Technology Group Co., Ltd., Beijing (CN); Beijing Boe Optoelectronics Technology Co., Ltd., Beijing (CN)

(72) Inventor: Gang Yang, Beijing (CN)

(21) Appl. No.: 15/099,791

(22) Filed: Apr. 15, 2016

(30) Foreign Application Priority Data
Apr. 28, 2015 (CN) 201510543588.X

(51) Int. Cl. G06T 3/60; G06F 3/01; G06K 9/00

(52) U.S. Cl. CPC G06T 3/60; G06K 9/00006; G06F 3/013

(57) ABSTRACT

A display device and a picture display method. The display device comprises at least one fingerprint sensor arranged at a frame of the display device, an observation state determination module communicatively connected with the at least one fingerprint sensor, and a picture display module communicatively connected with the observation state determination module. The observation state determination module is configured to determine a user-required observation state based on fingerprint information received from the at least one fingerprint sensor. The picture display module is configured to adjust a direction of a picture displayed on a screen of the display device based on the user-required observation state received from the observation state determination module. The picture display method can be applied to the display device provided by the above technical solution.

### RELATED APPLICATIONS

The present application claims the benefit of Chinese Patent Application No. 201510543588.X, filed on Apr. 28, 2015, the entire disclosure of which is incorporated herein by reference.

### FIELD OF THE INVENTION

This disclosure relates to the field of communication technology, particularly to display devices and picture displays.

### BACKGROUND

In daily life, the user often needs to adjust an observation state of a display device based on actual requirements. Hence, the existing display device mostly has to adjust the display direction of the picture based on the observation state of the display device, so as to enable the user to view the displayed picture upright on the screen of the display device.

Specifically, observation states of a display device generally includes vertical screen upright vision state, vertical screen reversed vision state, horizontal screen upright vision state and horizontal screen reversed vision state. These observation states are all relative to an observation direction of the user rather than placement states of the display device in the upper and lower directions determined by gravity. In order to enable the user to view the uprightly displayed picture when the display device is in any observation state, the existing display device is generally provided with a gravity sensor, for determining the observation state of the display device by determining the gravity direction, thereby controlling the direction of the picture displayed on the screen of the display device, so as to enable the user to observe the displayed picture upright on the screen. For example, when the user reverses the display device, the gravity sensor determines that the display device is in the vertical screen reversed vision state, thereby enabling the display device to adjust the picture displayed on the screen, so that the upper part of the picture approaches the lower frame of the screen, thus enabling the user to observe the displayed picture upright on the screen.

However, in actual applications, the state of the user per se often affects the determination on the observation state of the display device. For example, when the user lies on the right side to observe the display device, for the user, the observation state of the display device is the normal vertical screen upright vision state. Hence, the upper part of the picture should be made to approach the upper border of the screen so as to enable the user to observe the uprightly displayed picture; however, actually, since the frame at one side of the display device is located at the upper part in the gravity direction, the gravity sensor will determine that the display device is in the horizontal screen upright vision state or the horizontal screen reversed vision state, and then the display device will adjust the display direction of the picture to enable the upper part of the picture to approach the frame at one side of the display device, such that the user cannot would not observe the upright displayed picture. This results in inconvenience to the user observation by controlling the direction of the picture displayed on the screen solely by utilizing a gravity sensor.

### SUMMARY OF THE INVENTION

Embodiments of the present invention provide a display device and a picture display method, aiming to avoiding or mitigating one or more of the above problems.

Therefore, Embodiments of the present invention provide the following technical solutions.

An embodiment of the present invention provides a display device, the display device comprising at least one fingerprint sensor arranged at a frame of the display device, an observation state determination module communicatively connected with the at least one fingerprint sensor, and a picture display module communicatively connected with the observation state determination module. The observation state determination module is configured to determine a user-required observation state based on fingerprint information received from the at least one fingerprint sensor. Further, the picture display module is configured to adjust a direction of a picture displayed on a screen of the display device based on the user-required observation state received from the observation state determination module, thus enabling the user to observe an uprightly displayed picture on the screen.

In some embodiments, a picture display method is provided that may be applied to a display device as stated in the above technical solution, the picture display method comprising: an observation state determination module determining a user-required observation state based on fingerprint information received from the at least one fingerprint sensor; and a picture display module adjusting a direction of a picture displayed on a screen of the display device based on the user-required observation state received from the observation state determination module, so as to enable the user to observe an uprightly displayed picture on the screen.

### BRIEF DESCRIPTION OF THE DRAWINGS

The drawings explained here are used for providing further understanding to this disclosure, which constitute one part of this disclosure. The schematic embodiments illustrated herein and the explanations thereof are used for explanation purposes, and do not constitute inappropriate definitions to the present invention. In the drawings:

FIG. 1 is a structural schematic view of a display device provided by an embodiment of the present invention;

FIG. 2 is a structural schematic view of an observation state determination module in FIG. 1;

FIG. 3 is a structural schematic view of another display device provided by an embodiment of the present invention;

FIG. 4 is a structural schematic view of a picture display module in FIG. 1;

FIG. 5 is another structural schematic view of the picture display module in FIG. 1; and

FIG. 6 is a flow chart of a picture display method provided by an embodiment of the present invention.

### DETAILED DESCRIPTION OF THE INVENTION

In order to explain the disclosed embodiments, they will be described in detail with reference to the drawings of the description next. The following reference signs will be used throughout the figures:
10—observation state determination module
20—picture display module
30—observation state setting module
11—fingerprint information integration unit
12—state change determination unit
13—observation state determination unit
21—eyes-positions acquisition unit
22—display area determination unit
23—picture display unit
24—sight line focus acquisition unit

Referring to FIG. 1, an embodiment of the present invention provides a display device, the display device comprising at least one fingerprint sensor arranged at a frame of the display device, an observation state determination module 10 communicatively connected with the at least one fingerprint sensor, and a picture display module 20 communicatively connected with the observation state determination module 10.

For example, in the event that the at least one fingerprint sensor includes a plurality of fingerprint sensors, the plurality of fingerprint sensors can be uniformly distributed on the frame of the display device. The plurality of fingerprint sensors can be arranged on the same face of the screen of the display device, and can also be arranged on opposite faces of the screen of the display device, and can be further arranged on a side face of the display device. It should be understood that when the user holds the display device in hand, his fingers will naturally be at different positions of the frame. Moreover, when the display device is in different observation states, the positions of the respective fingers on the frame are also different. Therefore, the current observation state of the display device can be obtained from analysis by using a plurality of fingerprint sensors to acquire the positions of the fingers when the user holds the display device in hand. In some embodiments, the fingerprint sensors can use semiconductor fingerprint sensors or optical fingerprint sensors. Since the volume of the semiconductor fingerprint sensor is much less than the optical fingerprint sensor, when the embodiment of the present invention is applied into a portable display device with a relatively small volume, the semiconductor fingerprint sensor may be used.

In some embodiments, even if the display device is only provided with a unique fingerprint sensor, different fingerprints of different fingers of the user may correspond to different observation states. For example, the observation state of the display device can be changed when the user presses the fingerprint sensor through fingerprints of different fingers (thus it can be seen that in the event that the display device is only provided with one fingerprint sensor, it can also determine at least ten different corresponding observation states). Therefore, this disclosure does not define the number of the fingerprint sensors specifically. A person having ordinary skill in the art can set the number of the fingerprint sensors arranged on the display device reasonably based on the factors such as cost, user requirements, and hardware configuration conditions.

The observation state determination module 10 is configured to determine a user-required observation state based on fingerprint information received from the at least one fingerprint sensor. As described above, there is a certain corresponding relationship between the positions of the fingers of the user and the observation states of the display device, and the user-required observation state can be determined based on the corresponding relationship. The user-required observation state includes, for example, vertical screen upright vision state, vertical screen reversed vision state, horizontal screen upright vision state, and horizontal screen reversed vision state. The above various observation states are all relative to the observation direction of the user, and are unrelated to the shape of the display device itself and its upper and lower states in the gravity direction. For example, for a display device of either a mobile phone or a panel computer with a rectangular screen or certain smart watch with a round or elliptical screen, the conventional display state thereof can be regarded as the vertical screen upright vision state, thereby the vertical screen reversed vision state, the horizontal screen upright vision state and the horizontal screen reversed vision state can be set correspondingly. It can be understood that the above observation states are only concepts set for convenience of describing this disclosure, and would not result in inappropriate definition to specific settings of the skilled person in the art.

The picture display module 20 is configured to adjust a direction of a picture displayed on a screen of the display device based on the user-required observation state received from the observation state determination module 10, so as to enable the user to observe an uprightly displayed picture on the screen. For example, in a display device applying the Android platform: first, all information contained in the picture to be displayed is generated based on the program initiated by the user, thereby rendering the picture on the screen (i.e., performing display) through operations of, for example, displaying, hiding, and redrawing based on the information.

In some implementations, at least one fingerprint sensor is arranged at the frame of the display device, positions of respective fingers of the user relative to the frame of the display device are detected by the fingerprint sensor to determine the user-required observation state, and the direction of the picture displayed on the screen of the display device is adjusted so as to enable the user to observe the upright displayed picture on the screen. This determines the user-required observation state through the fingerprint information obtained by the fingerprint sensor, the states (such as lie on one's back, lie on the side) of the user per se will not affect the determination of the observation state. Hence, compared with the prior art in which the state of the user per se often affects the determination on the observation state of the display device, in this embodiment, no matter how the state of the user per se is, the uprightly displayed picture can be observed on the screen of the display device, thereby improving convenience for the user to observe the upright displayed picture on the screen when the observation state of the display device changes.

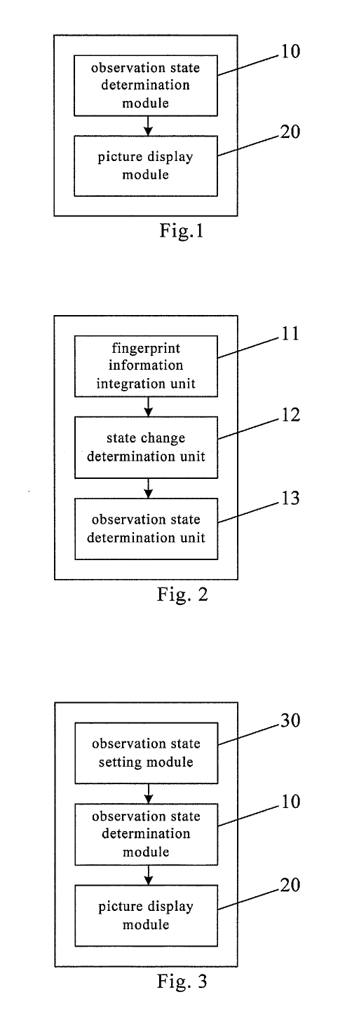

Referring to FIG. 2, the observation state determination module 10 can comprise a fingerprint information integration unit 11, a state change determination unit 12 and an observation state determination unit 13. The specific functions thereof are respectively as follows.

The fingerprint information integration unit 11 is configured to integrate the fingerprint information received from the at least one fingerprint sensor into integrated fingerprint information. The integrated fingerprint information includes types and positions of user fingerprints detected by each fingerprint sensor. The types of the user fingerprints are hands and fingers where the fingerprints locate specifically (e.g., thumb of left hand, middle finger of right hand), and the positions of the user fingerprints are positions where the fingerprint sensors to which the detected fingerprints correspond locate. The above information is integrated into integrated fingerprint information.

The state change determination unit 12 is communicatively connected with the fingerprint information integration unit 11, and is configured to analyze the integrated fingerprint information and determine whether the types and the positions of the user fingerprints in the integrated fingerprint information meet a preset condition. The purpose of such a configuration lies in avoiding, in the process of the user observing the display device, wrong determination for the display device caused by change of the holding manner so as to result in accidental change of the picture direction. Therefore, before determining the observation state of the display device, some embodiments first determine whether the types and the positions of the fingerprints shown in the integrated fingerprint information meet the preset condition, thereby determining whether the display direction of the picture is to be changed based on the integrated fingerprint information.

Specifically, for example, for a small display device such as a mobile phone, the user may possibly enable the fingerprints of several fingers to contact the frame of the display device simultaneously when holding it. Then, the preset condition can be that only two fingerprint sensors detect the fingerprints. More specifically, for example, if the fingerprint sensor located at the right side frame of the display device detects the fingerprint of the thumb of the right hand and the fingerprint sensor located at the left side frame of the display device detects the fingerprint of the little finger of the right hand, the result of the above determination is “YES.” Correspondingly, if the fingerprint sensor located at the right side frame of the display device detects the fingerprint of the thumb of the right hand and the fingerprint sensor located at the left side frame of the display device detects the fingerprints of the forefinger, the middle finger and the little finger of the right hand, the result of the above determination will be “NO.”

However, for a relatively large display device such as a panel computer, in most cases, it is mostly a single fingerprint contacting the frame of the display device or no fingerprint contacting the frame of the display device when the user holds it, then the preset condition can be that the fingerprint sensors located at frames of two sides of the display device detect the fingerprints of the left hand fingers and the fingerprints of the right hand fingers respectively. For example, if the fingerprint sensor located on the upper side frame of the display device detects the fingerprint of the thumb of the left hand and the fingerprint sensor located at the lower side frame of the display device detects the fingerprint of the thumb of the right hand, the result of the above determination is “YES.” If the fingerprint sensor located on the upper side frame of the display device detects the fingerprint of the thumb of the left hand and the fingerprint sensor located at the right side frame of the display device detects the fingerprint of the forefinger of the left hand, the result of the above determination will be “NO.”

Another alternative preset condition is the user's strength of pressing the fingerprint sensor. If it is detected as light touch, the result of the above determination will be “NO,” whereas if it is detected as heavy press, the result of the above determination will be “YES.” The definition of scopes of the light touch and the heavy press may be, for example, set by the user.

It can be understood that based on the difference in actual conditions of the user and the display device, the user's gesture change when using the display device is also not the same. Hence, the user can set the above preset condition reasonably based on his own condition. This disclosure will not specifically define the preset condition.

The observation state determination unit 13 is communicatively connected with the fingerprint information integration unit 11 and the state change determination unit 12, and is configured to determine a user-required observation state corresponding to the integrated fingerprint information received from the fingerprint information integration unit 11 according to a preset corresponding relationship between the integration fingerprint information and the observation state when the types and the positions of the user fingerprints in the integrated fingerprint information meet the preset condition. There is a corresponding relationship between the integrated fingerprint information and the user-required observation state, and the corresponding relationship, for example, can be stored in the observation state determination unit in the form of a mapping table. The mapping table can be pre-stored in the observation state determination unit by the manufacturer of the display device, and can also be set by the user himself through the human-machine interactive interface according to requirements after obtaining the display device and inputted into the display device, and then the corresponding relationship set by the user is converted into the mapping table and stored by the observation state determination unit.

Referring to FIG. 3, in order to achieve the corresponding relationship between the integrated fingerprint information of the user and the user-required observation state as stated in the above technical solution, the display device provided by an embodiment of the present invention can further comprise an observation state setting module 30 communicatively connected with the observation state determination module 10.

The observation state setting module 30 is configured to set a corresponding relationship between the integrated fingerprint information and the observation state based on observation state setting information inputted by the user, and transmit the corresponding relationship to the observation state determination module 10. Specifically, the user can input information, such as fingerprint information, different corresponding observation states when the sensors detect different fingerprints, and the above preset condition to the observation state setting module 30 through the human-machine interactive interface such as a touch screen, and the observation state setting module 30 establishes a corresponding relationship mapping table based on the above information and input the information such as the corresponding relationship mapping table and the user's fingerprints into the observation state determination module 10.

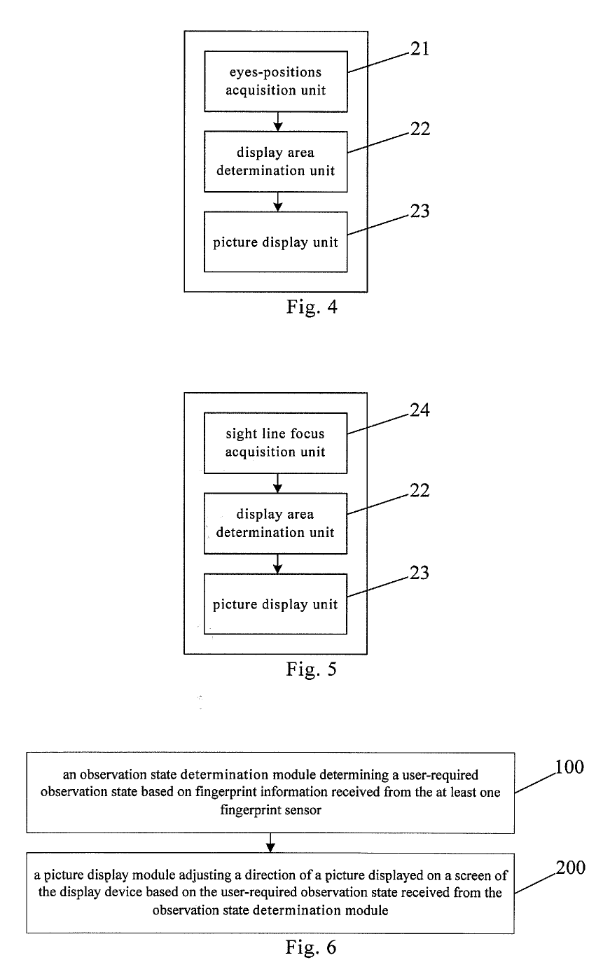

Referring to FIG. 4, further, in addition to the vertical screen upright vision state, the vertical screen reversed vision state, the horizontal screen upright vision state, and the horizontal screen reversed vision state mentioned in the above contents, an embodiment of the present invention can also allow the user to observe the upright displayed picture when the display device is in an oblique state between the vertical state and the horizontal state. In order to enable the user to observe the uprightly displayed picture when the display device is in the oblique state. The picture display module 20 can comprise an eyes-positions acquisition unit 21, a display area determination unit 22 and a picture display unit 23.

The eyes-positions acquisition unit 21 is configured to acquire positive projection positions of a user's left eye and right eye on the screen. For example, the eyes-positions acquisition unit 21 can be combined with the camera of the display device, to take a picture of the user's face in the process of using the display device by the user, determine the positions of the eyes of the user through area determination etc., and finally determine the positive projection positions of the eyes of the user on the screen, thereby substantially determining the scope that can be observed by the user on the screen of the display device.

The display area determination unit 22 is communicatively connected with the eyes-positions acquisition unit 21, and is configured to determine a display area on the screen based on the positive projection positions of the user's left eye and right eye on the screen. Specifically, since the display device is in the oblique state, if it is desired to enable the user to observe the upright displayed picture, the direction of the picture displayed by the display device does not conform to the screen of the display device completely, then a correct-size display area can be determined on the screen and the picture can be displayed in this display area, thereby enabling the user to view a normally displayed picture. It can be understood that the positive projection positions of the left eye and the right eye of the user on the screen are located within the display area determined by the display area determination unit 22, thereby facilitating the user to observe the picture to a maximum extent.

The picture display unit 23 is communicatively connected with the display area determination unit 22, and is configured to display a picture that needs to be displayed within the display area, so as to enable the user to observe an uprightly displayed picture on the screen. In specific implementations, the picture display unit 23 for example establishes a rectangular coordinate system on a display plane of a mobile terminal (i.e., a plane where the picture displayed by its screen is located), and determine a straight line formed by the positive projections of the left eye and the right eye in the rectangular coordinate system based on the positive projection positions of the left eye and the right eye of the user on the screen, and then perform picture display in the display area based on the angle formed by the straight line and the coordinate axis of the above coordinate system, so as to enable the user to observe the uprightly displayed picture.

Further, the display area can be a rectangular display area (that is, the screen is a rectangle), a connecting line between the positive projection positions of the user's left eye and right eye on the screen is parallel to a pair of opposite sides of the rectangular display area. Specifically, a straight line formed by the positive projection positions of the left eye and the right eye of the user on the screen in the above rectangular coordinate system is determined, the picture display module 20 forms a rectangular display area based on the straight line, thereby enabling a pair of opposite sides of the rectangular display area to be parallel to the straight line. It can be understood that it can be determined to which one of the vertical screen display and the horizontal screen display the picture displayed in the display area corresponds based on whether the above straight line is parallel to the long side or the short side of the rectangular display area. By means of the above technical measure, the picture displayed in the display area and the picture displayed by the normal rectangular screen are consistent in their shapes, so that the user achieves a better viewing effect.

Referring to FIG. 5, for the above technical solution, a sight line focus acquisition unit 24 can also be used to replace the eyes-positions acquisition unit 21. The sight line focus acquisition unit 24 is configured to acquire a sight line focus position of a user, the sight line focus position being a position of an intersecting point of a left eye sight line and a right eye sight line of a user on a plane where the screen locates. The light line acquisition unit 24 can also be integrated with the camera of the display device. Specifically, for example, an infrared auxiliary light source can be used to irradiate the human face, to form a reflected image on the surface of eye cornea, this reflected image is called Purkinje spot. When the human eyes gaze at different positions of the screen, the eyeballs will turn correspondingly, assume that the viewer's head does not move, because the position of the infrared auxiliary light source is fixed, and the eyeball is an approximate sphere, when the eyeball moves, it can be regarded that the absolute position of the Purkinje spot is unchanged, while the positions of the iris and the pupil will be changed correspondingly, thus the relative positional relationship between the Purkinje spot and the iris and the pupil will also be changed. The determination of such a relative positional relationship can be carried out through image processing, then the direction of the sight line can be obtained from the relative positional relationship, and thus a sight line focal position can be obtained.

When the above sight line focus acquisition unit 24 is used, the display area determination unit 22 in the picture display module 20 is configured to determine a display area on the screen based on the sight line focus position, wherein the sight line focus position is located within the display area. Moreover, the sight line focus position can be located at a geometric center of the display area, thereby enabling the user to achieve a better observing effect when observing the picture within the display area.

Further, in the case of acquiring the above positive projection positions of the left eye and the right eye of the user on the screen or the sight line focus positions of the eyes of the user, an iris determination module can also be added. The iris determination module determines whether the acquired eyes information comes from the user based on the acquired related information of the eyes, thereby determining whether the display area is to be determined based on the acquired related information of the eyes. In some implementations, if the iris determination module is added, the user may need to store the iris information of his eyes into the iris determination module in advance.

It should be noted that the display area can also be determined based on the positive projection positions of the left eye and the right eye of the user on the screen and the sight line focus position of the eyes of the user simultaneously. Specifically, for example, the above eyes-positions acquisition unit 21 and the sight line focus acquisition unit 24 can be integrated into a sight line scope acquisition module. The positive projection positions of the left eye and the right eye of the user on the screen and the sight line focus position of the eyes of the user are obtained simultaneously using the module, and the center of the display area is determined using the sight line focus position of the eyes of the user. The size of the display area is determined using the positive projection positions of the left eye and the right eye of the user on the screen, so as to select the display area on the screen.

It should be understood that, in some embodiments, the display area may have the same shape as the screen, so that abnormal distortion, which may affect the viewing experience of the user, will not occur when the picture is displayed within the display area. In order to determine the oblique state, it needs to be preset in the observation state setting module 30, so that the oblique state corresponds to the particular integrated fingerprint information. For example, for a rectangular display device, a fingerprint sensor can be arranged at the top corner of the frame of the display device, so as to determine that the user-required observation state is an oblique state when the fingerprint of a particular finger of the user contacts the fingerprint sensor at this position.

Regarding the picture display performed under the above oblique state, except for the display area, other parts of the screen can be displayed as black. Through this setting, on the one hand, the affect of the non-display area other than the display area to the user viewing the display device can be avoided, on the other hand, electricity consumed by the non-display area can also be saved.

Referring to FIG. 6, an embodiment of the present invention further provides a picture display method, which can be applied to a display device as stated in the above technical solutions, the picture display method comprising:

At step 100, an observation state determination module determines a user-required observation state based on fingerprint information received from the at least one fingerprint sensor. The fingerprint information specifically may include the types of the fingerprints (such as the fingerprint of the forefinger of the left hand, the fingerprint of the middle finger of the right hand) of the user detected by the at least one fingerprint sensor, and the number of the fingerprints, even may include the fingerprint state (such as light touch or heavy press) and so on.

At step 200, a picture display module adjusts a direction of a picture displayed on a screen of the display device based on the user-required observation state received from the observation state determination module, so as to enable the user to observe an uprightly displayed picture on the screen. Specifically, when the user holds the display device in hand, his fingers will be at different positions on the frame naturally, moreover, when the display device is in different observation states, the positions of the fingers on the frame are also different. Therefore, the current observation state of the display device can be obtained from analysis by acquiring positions of the fingers through the fingerprint sensor when the user holds the display device in hand.

The advantages of the picture display method provided by the present invention over the prior art are same as those of the above display device over the prior art, which will not be repeated here.

In the above description of the implementing modes, the specific features, structures, materials or characteristics can be combined in appropriate manners in any one or more embodiments or examples.

What are stated above are only specific implementations of the present invention. However, the protection scope of the present invention is not limited to this. Any modifications or replacements that can be easily conceived by the skilled person familiar with the present technical field within the technical scope disclosed by this disclosure should be encompassed within the protection scope of the present invention. Therefore, the protection scope of the present invention should be subject to the protection scopes of the claims.

1. A display device comprising:
at least one fingerprint sensor arranged at a frame of the display device;
an observation state determination module communicatively connected with the at least one fingerprint sensor; and
a picture display module communicatively connected with the observation state determination module;
wherein the observation state determination module is configured to determine a user-required observation state based on fingerprint information received from the at least one fingerprint sensor; and
wherein the picture display module is configured to adjust a direction of a picture displayed on a screen of the display device based on the user-required observation state received from the observation state determination module, so as to enable the user to observe an uprightly displayed picture on the screen.

2. The display device according to claim 1, wherein the observation state determination module comprises:
a fingerprint information integration unit configured to integrate the fingerprint information received from the at least one fingerprint sensor into integrated fingerprint information, the integrated fingerprint information including types and positions of user fingerprints detected by each fingerprint sensor;
a state change determination unit communicatively connected with the fingerprint information integration unit, configured to analyze the integrated fingerprint information and determine whether the types and the positions of the user fingerprints in the integrated fingerprint information meet a preset condition; and
an observation state determination unit communicatively connected with the fingerprint information integration unit and the state change determination unit, wherein the observation state determination unit is configured to determine a user-required observation state corresponding to the integrated fingerprint information received from the fingerprint information integration unit according to a preset corresponding relationship between the integration fingerprint information and the observation state when the types and the positions of the user fingerprints in the integrated fingerprint information meet the preset condition.

3. The display device according to claim 2, further comprising:
an observation state setting module communicatively connected with the observation state determination module,
wherein the observation state setting module is configured to set a corresponding relationship between the integrated fingerprint information and the observation state based on observation state setting information inputted by the user, and transmit the corresponding relationship to the observation state determination module.

4. The display device according to claim 1, wherein the observation state comprises an oblique state, and wherein the picture display module comprises:
an eyes-positions acquisition unit configured to acquire positive projection positions of a user's left eye and right eye on the screen;
a display area determination unit communicatively connected with the eyes-positions acquisition unit and configured to determine a display area on the screen based on the positive projection positions of the user's left eye and right eye on the screen, wherein the positive projection positions of the user's left eye and right eye on the screen are located within the display area; and
a picture display unit communicatively connected with the display area determination unit and configured to display a picture that needs to be displayed within the display area, so as to enable the user to observe an uprightly displayed picture on the screen.

5. The display device according to claim 4, wherein the display area is a rectangular display area, and wherein a connecting line between the positive projection positions of the user's left eye and right eye on the screen is parallel to a pair of opposite sides of the rectangular display area.

6. The display device according to claim 1, wherein the observation state comprises an oblique state, and wherein the picture display module comprises:
a sight line focus acquisition unit configured to acquire a sight line focus position of a user, the sight line focus position being a position of an intersecting point of a left eye sight line and a right eye sight line of a user on a plane where the screen locates;
a display area determination unit communicatively connected with the sight line focus acquisition unit, configured to determine a display area on the screen based on the sight line focus position, wherein the sight line focus position is located within the display area; and
a picture display unit communicatively connected with the display area determination unit and configured to display a picture that needs to be displayed within the display area, so as to enable the user to observe an uprightly displayed picture on the screen.

7. The display device according to claim 6, wherein the sight line focus position is located at a geometric center of the display area.

8. The display device according to claim 4, wherein the display area has a same shape as the screen.

9. The display device according to claim 4, wherein except for the display area, other parts of the screen are displayed as black.

10. The display device according to claim 5, wherein the display area has a same shape as the screen.

11. The display device according to claim 5, wherein except for the display area, other parts of the screen are displayed as black.

12. The display device according to claim 6, wherein the display area has a same shape as the screen.

13. The display device according to claim 6, wherein except for the display area, other parts of the screen are displayed as black.

14. The display device according to claim 7, wherein the display area has a same shape as the screen.

15. The display device according to claim 7, wherein except for the display area, other parts of the screen are displayed as black.

16. A picture display method, applied to a display device according to claim 1, wherein the picture display method comprises:
determining, via an observation state determination module, a user-required observation state based on fingerprint information received from the at least one fingerprint sensor; and
adjusting, via a picture display module, a direction of a picture displayed on a screen of the display device based on the user-required observation state received from the observation state determination module, so as to enable the user to observe an uprightly displayed picture on the screen.
